(19) United States
(12) Patent Application Publication
(10) Pub. No.: US 2025/0278868 A1
(43) Pub. Date: Sep. 4, 2025

(54) APPLYING AND BLENDING NEW TEXTURES TO SURFACES ACROSS FRAMES OF A VIDEO SEQUENCE

(71) Applicant: Adobe Inc., San Jose, CA (US)

(72) Inventors: Jiahui HUANG, Vancouver (CA); Joon-Young LEE, San Jose, CA (US)

(73) Assignee: Adobe Inc., San Jose, CA (US)

(21) Appl. No.: 18/592,313

(22) Filed: Feb. 29, 2024

(51) Int. Cl. G06T 11/00; G06T 3/18; G06T 7/11; G06T 7/20; G06T 7/33; G06T 7/73

(52) U.S. Cl. CPC G06T 11/001; G06T 3/18; G06T 7/11; G06T 7/20; G06T 7/33; G06T 7/73; G06T 2207/10016

(57) ABSTRACT

Embodiments are disclosed for a process of applying and blending new textures to surfaces across frames of a video sequence. The method may include obtaining a new texture for a selected region of a video frame of a video sequence. The method may further comprise generating a mesh for the selected region of the first video frame that includes a plurality of control points. The method may further comprise determining control point location data for each of the plurality of control points for additional video frames of the video sequence and using the control point location data to generate a plurality of warped video frames by applying the new texture to the additional video. The method may further comprise generating blended video frames by blending the new texture in the warped video frames and providing a modified version of the video sequence using the generated blended video frames.

### BACKGROUND

Effective video editing can be vital for storytelling, marketing, and content creation. Video editing has transitioned from being a highly specialized skill to a common skill being performed by content creators. With the rise of user-generated content, there is an increasing demand for tools that simplify the editing process, making it accessible for amateurs while enhancing the efficiency for professionals. One challenging aspect of video editing is the modification or replacement of textures on physical surfaces within videos.

### SUMMARY

Introduced here are techniques/technologies that allow a digital design system to apply and blend new textures to surfaces across video frames of a video sequence.

More specifically, in one or more embodiments, a digital design system processes a video sequence through a pipeline to generate a new texture in a video frame of the video sequence and propagate the new texture to additional video frames. The digital design system addresses two challenges: consistent texture propagation, and adaptive color adjustment for varying lighting conditions across video frames. The digital design system first generates a new texture based on a selection of a region and a prompt. The prompt can indicate an object or element to add to replace in the selected region of a starting video frame of the video sequence. After generating the new texture, the digital design system uses a mesh tracker to generate a mesh of control points for the selected region. The control points in the mesh correspond to pixels of the video frame in the selected region where the new texture was generated. The motion of the control points between the starting video frame and the next video frame is determined using an optical flow map. This data is used to determine transformation functions to track the movements of the control points and then warp the new texture in the next video frame. The mesh tracker repeats the process frame-by-frame through the video sequence to generate warped video frames with the new texture applied. A blending module is then used to merge the new texture into the warped video frames. The blending module uses data from the pixels on the border of the selected region to apply varying lighting conditions to the new texture to ensure smooth transitions. For example, if the video sequence includes a person or object transitioning from sunlight to shadow, the blending module can apply that transition to the new texture. This process can be performed in real-time to generate a modified video sequence with the new texture propagated from the starting video frame to an ending video frame.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of applying and blending new textures to surfaces across frames of a video sequence in accordance with one or more embodiments;

FIG. 2 illustrates a diagram of a texture generation module for generating a new texture in a video frame in accordance with one or more embodiments;

FIG. 3 illustrates a diagram of a mesh tracking module for warping a new texture across video frames of a video sequence in accordance with one or more embodiments;

FIG. 4 illustrates a diagram of a texture blending module for blending a new texture into a video frame of a video sequence in accordance with one or more embodiments;

FIG. 5 illustrates a schematic diagram of a digital design system in accordance with one or more embodiments;

FIG. 6 illustrates a flowchart of a series of acts in a method of applying and blending new textures to surfaces across frames of a video sequence in accordance with one or more embodiments; and

FIG. 7 illustrates a block diagram of an exemplary computing device in accordance with one or more embodiments.

### DETAILED DESCRIPTION

One or more embodiments of the present disclosure include a digital design system for applying and blending new textures to surfaces across frames of a video sequence. Some existing techniques for propagating textures across video frames require tracking the coordinates of every pixel within the texture. For example, some existing techniques employ chaining dense optical flows. However, these existing techniques provide limited control over texture deformation, frequently resulting in unsatisfactory warping effects. Furthermore, optical flow can be highly susceptible to errors in flow prediction, especially in the presence of occlusions. For example, a single mistake during an intermediate step can completely compromise the overall tracking result. In addition, existing techniques merely propagate a texture to the other frames, which can be insufficient to produce optimal visual outcomes, particularly when there are dramatic shifts in lighting conditions across frames.

To address these and other deficiencies in conventional systems, the digital design system of the present disclosure utilizes a pipeline that includes a texture generator that generates a texture in a selection region of a frame of a video sequence, a mesh tracking module that ensures that the new texture is propagated accurately through additional frames of the video sequence, and a blending module that ensures the selected region with the new texture is smoothly blended and integrated into the rest of the video frame, including accounting for any lighting variations.

The digital design system of the present disclosure presents improved texture propagation through frames of a video, while addressing the limitations of the existing techniques. One advantage of the digital design system of the present disclosure is the use of the mesh tracker module to generate and track a number of control points. By tracking the new texture as an integrated mesh with a number of control points, deformations of the mesh can be captured by smooth transformation functions based on the control points. This provides advantages over techniques that track all pixels as it utilizes fewer computing resources and performs faster. Another advantage of the digital design system of the present disclosure is that the blending process ensures the seamless integration of the texture into target frames, while also accounting for variations and changes in lighting conditions. Another advantage is that the technique can perform a backwards optical flow, or reverse optical flow, process to identify control points with inaccurate tracking. By doing so, the digital design system of the present disclosure can prune any such control points from the control points mesh, ensuring these control points with inaccurate tracking do not adversely affect the warping of the control points and the new texture into subsequent frames of the video sequence.

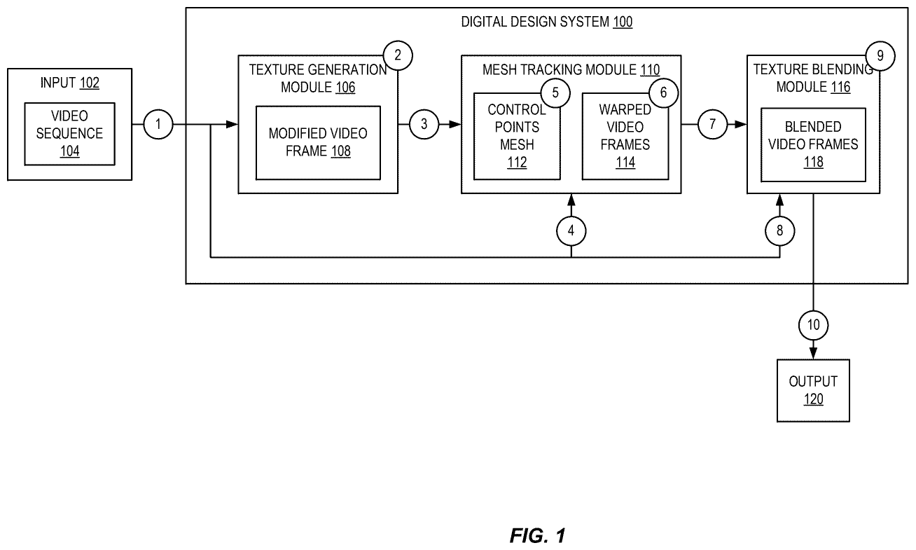

FIG. 1 illustrates a diagram of a process of applying and blending new textures to surfaces across frames of a video sequence in accordance with one or more embodiments. As shown in FIG. 1, a digital design system 100 receives an input 102, as shown at numeral 1. For example, the digital design system 100 receives the input 102 from a user via a computing device or from a memory or storage location, where the input 102 includes at least a video sequence (e.g., video sequence 104). In one or more embodiments, the input 102 further includes a selection of a region within a frame of the video sequence 104. In one or more embodiments, the input 102 further includes a text prompt indicating a texture to be applied to the selected region within the frame of the video sequence. In some embodiments, the selection of the region within a frame of the video sequence 104 and/or the text prompt can be received in one or more inputs subsequent to input 102. In one or more embodiments, the input 102 can be provided in a graphical user interface (GUI). For example, the video sequence 104 can be provided to the digital design system 100, or a user can indicate a storage location (e.g., on a computing device) or a URL to a location storing the video sequence 104.

The input 102 is received by a texture generation module 106. In one or more embodiments, the texture generation module 106 generates a modified video frame 108 of the video sequence 104, at numeral 2. In one or more embodiments, the modified video frame 108 includes a new texture generated by the texture generation module 106 for a selected region of a video frame (e.g., a keyframe) of the video sequence 104. The video frame can be user-selected or selected by the digital design system 100. In one or more embodiments, the texture generation module 106 is machine learning model trained to modify an image, or video frame, by adding or removing content from the image. The texture generation module 106 can add a texture, an object, or an element to the image based on the text prompt. In the absence of a text prompt, the texture generation module 106 can fill in the selected region based on the selected region's surroundings. In one or more embodiments, the texture generation module 106 includes a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data. In one or more embodiments, the modified video frame 108 generated by the texture generation module 106 is then passed to a mesh tracking module 110, as shown at numeral 3. In one or more embodiments, the video sequence 104 is also passed to the mesh tracking module 110, as shown at numeral 4.

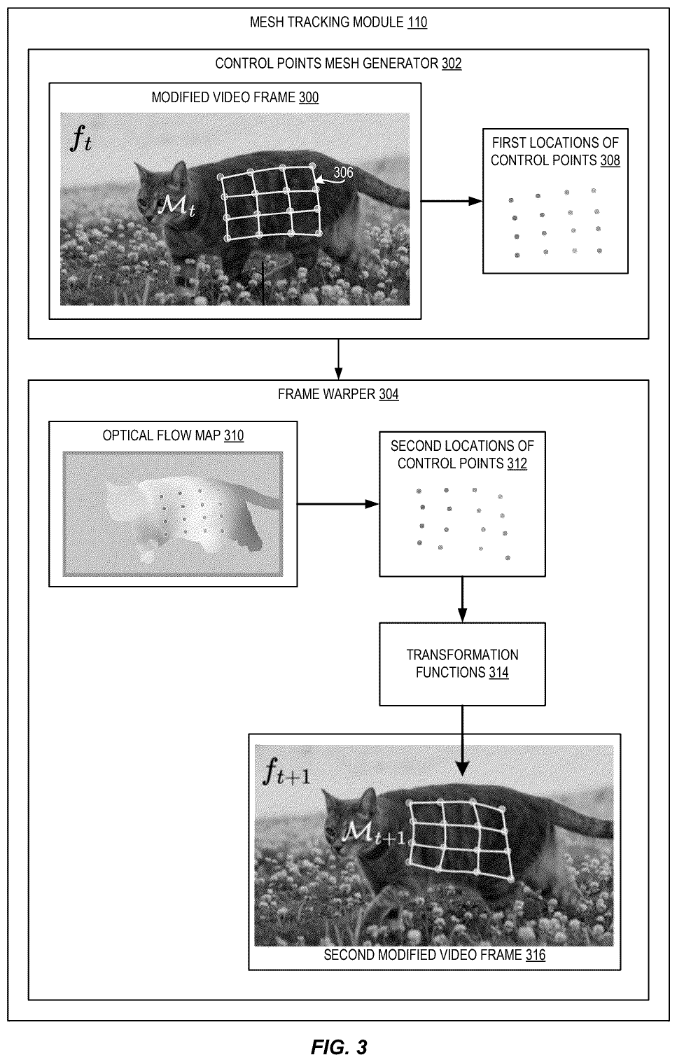

In one or more embodiments, the mesh tracking module 110 automatically propagates the texture generated in the modified video frame 108 to all other frames in the video sequence 104 by warping the texture in line with the deformation of the surface receiving the texture. In one or more embodiments, the mesh tracking module 110 generates a control points mesh 112 for the selected region and generates control point location data, at numeral 5. The control points mesh 112 includes a plurality of control points distributed throughout the selected region with the new texture in the modified video frame 108. Each control point in the control points mesh 112 corresponds to a pixel in the modified video frame 108. After generating the control points mesh 112 for the modified video frame, the mesh tracking module 110 generates control point location data for each control point to determine how to warp the control points across the video frames of the video sequence 104. The mesh tracking module 110 analyzes the motion of each control point of the control points mesh 112 to generate the control point location data for each control point. Using the control point location data, the mesh tracking module 110 generates warped video frames 114, at numeral 6. After performing the forward tracking, the mesh tracking module 110 performs a backwards warping process to warp the texture generated in the modified video frame 108 across other frames of the video sequence 104, resulting the warped video frames 114. Additional details of the mesh tracking module 110 are described with respect to FIG. 3.

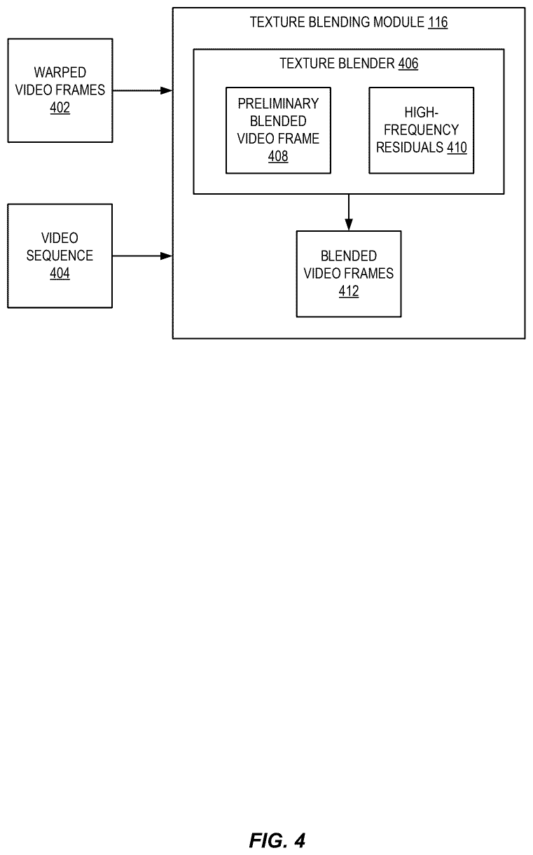

The warped video frames 114 are then sent to a texture blending module 116, as shown at numeral 7. In one or more embodiments, the video sequence 104 is also passed to the texture blending module 116, as shown at numeral 8. The texture blending module 116 can be configured to generate blended video frames 118 using the warped video frames 114 and the video sequence 104, at numeral 9. In some embodiments, the texture blending module 116 generates the blended video frames 118, in which the new texture generated in the warped video frames 114 are blended with the original content in the original source video frame (e.g., from the video sequence 104) to ensure the new texture visually matches any shifting lighting conditions of the original source video frames. In one or more embodiments, the texture blending module 116 performs a blending process for each of the warped video frames 114 of video sequence 104, resulting in blended video frames 118. Additional details of the texture blending module 116 are described with respect to FIG. 4.

After the texture blending module 116 generates the blended video frames 118, the blended video frames 118 can be sent as an output 120, as shown at numeral 10. In some embodiments, the blended video frames 118 can be used to generate a modified video sequence as the output 120. The modified video sequence can be rendered in real-time and presented as the output 120. In one or more embodiments, after the process described above in numerals 1-9, the output 120 is sent through a communications channel to the user device or computing device that provided the input, to another computing device associated with the user or another user, or to another system or application.

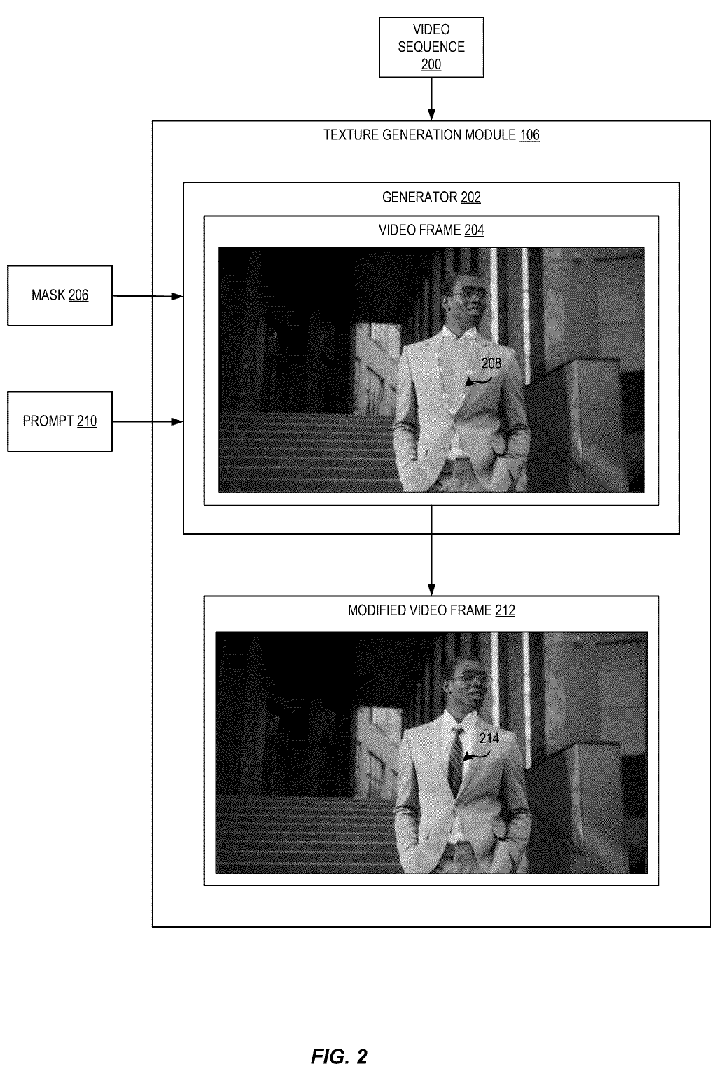

FIG. 2 illustrates a diagram of a texture generation module for generating a new texture in a video frame in accordance with one or more embodiments. As illustrated in FIG. 2, the texture generation module 106 can include a generator 202. In one or more embodiments, the generator 202 is configured to generate a new texture based on inputs received by the texture generation module 106. In some embodiments, the generator 202 can obtain the new texture, object, or element and apply the new texture, object, or element to the video frame. The generator 202 can perform image manipulation on the video frame 204, including removing and adding objects, removing and adding backgrounds, modifying elements in the video frame 204, etc. In one or more embodiments, the generator 202 is a text-based generator that includes a machine learning model.

In one or more embodiments, the texture generation module 106 can first receive an input that includes a video sequence 200. The generator 202 can further receive an input selecting a video frame 204 from the video sequence 200. The video frame 204 can be used as a keyframe, on which a new texture is to be generated for propagation through one or more other video frames of the video sequence 200. The texture generation module 106 can also receive a mask 206 and a prompt 210 as inputs. In one or more embodiments, the mask 206 and the prompt 210 can be received in the same input as the video sequence 200 or as one or more separate inputs. The mask 206 can be selected using as drawing tool that allows a user to define a selected region (e.g., selected region 208) of the video frame 204 where the new texture is to be generated. The prompt 210 can be text describing an object, element, etc. In the absence of a prompt, the generator 202 can fill in the selected region 208 based on the selected region's surroundings. In the example of FIG. 2, the prompt 210 can include be “tie,” to request a tie be added to the selected region 208. The generator 202, based on the prompt 210 generates the desired texture (e.g., a tie 214) in the selected region 208 of the video frame 204, resulting in modified video frame 212. Once the modified video frame 212 is generated, the texture generation module 106 can store the modified video frame 212 or send the modified video frame 212 to a mesh tracking module (e.g., mesh tracking module 110) for further processing.

FIG. 3 illustrates a diagram of a mesh tracking module for warping a new texture across video frames of a video sequence in accordance with one or more embodiments. As illustrated in FIG. 3, the mesh tracking module 110 can include a control points mesh generator 302 and a frame warper 304. In one or more embodiments, the control points mesh generator 302 is configured to generate a control points mesh for a selected region of a received video frame of a video sequence in which a new texture was generated. In one or more embodiments, the frame warper 304 is configured to warp the new texture from the received video frame across other video frames of the video sequence.

In one or more embodiments, the mesh tracking module 110 receives a modified video frame 300 from a texture generation module (e.g., texture generation module 106), as described in FIG. 1. The modified video frame 300, fₜ, is a video frame from a video sequence in which the texture generation module 106 generated a new texture in the selected region of the video frame. The control points mesh generator 302 then generates the control points mesh 306, Mt, for the selected region of the modified video frame 300. The control points mesh generator 302 can generate the control points mesh 306 by dividing the selected region into a grid based on the shape of the selected region in the modified video frame 300, where each vertex of the grid defines a location of a control point. The size of the grid can define the number and locations of the control points for the mesh, where a larger grid size results in fewer control points (e.g., due to fewer vertices), and vice versa. The control points mesh 306 depicted in FIG. 3 includes 16 control points, where each control point corresponds to a pixel within the selected region in the modified video frame 300. As the number of control points is a subset of the total number of pixels in the selected region, the mesh tracking module 110 utilizes fewer resources than other techniques that track every pixel. In one or more embodiments, the initial locations of the control points of the control points mesh 306 are uniformly distributed within the selected region (e.g., the distance between each control point is uniform or close to uniform), where the distance can be user-defined or system-defined. In some embodiments, the number of the control points of the control points mesh 306 is based on a user-defined or system-defined value. In one or more embodiments, the control points mesh 306 can also be visualized as first locations of control points 308, Cₜ.

In one or more embodiments, the control points mesh 306 is sent to the frame warper 304 to determine how to warp the new texture in the modified video frame 300 across other video frames in the video sequence. In one or more embodiments, the frame warper 304 performs a forward tracking process and a backwards warping process.

In one or more embodiments, the frame warper 304 accesses or retrieves an optical flow map 310 generated for the video sequence. The optical flow map 310 includes a plurality of mappings (e.g., one for each video frame for the video sequence), that includes motion data for each pixel of a corresponding frame. In one or more embodiments, the optical flow map 310 is generated using a machine learning model. In some embodiments, the optical flow map 310 is generated using a Recurrent All-Pairs Field Transforms (RAFT) machine learning model. The optical flow map 310 can be generated by the mesh tracking module 110, another module or component of the digital design system 100, or by a service external to the digital design system and retrieved or received by the frame warper 304.

In one or more embodiments, in the forward tracking process, the frame warper 304 determines how to warp the control points. To do so, the frame warper 304 defines two transformation functions: a similarity transformation function, Tᵣ, which represents rigid deformation, and a Thin-Plate transformation function, Tₛ, which represents non-rigid deformation. The frame warper 304 uses the optical flow map 310 for a next frame, fₜ₊₁ to analyze the individual motions of the control points in the control points mesh 306. By comparing the first locations of control points 308, Cₜ, in the modified video frame 300, fₜ, to second locations of control points 312, F(Cₜ), in the next video frame, fₜ₊₁, as determined from the optical flow map 310, the frame warper 304 can define the two transformation functions 314, as follows:

$${\hat{T}}_{r} = {argmin}_{{T}_{r}} ‖ {T}_{r} ( {C}_{t} ) - F ( {C}_{t} ) ‖$$

$${\hat{T}}_{s} = {argmin}_{{T}_{s}} ‖ {T}_{s} ( {C}_{t} ) - F ( {C}_{t} ) ‖$$

In one or more embodiments, the final transformation function, T, is the weighted combination of the two transformation functions, as follows:

$${C}_{t + 1} = T ( {C}_{t} ) = α {T}_{r} ( {C}_{t} ) + ( 1 - α ) {T}_{s} ( {C}_{t} )$$

where α can be a user-defined value that allows for control of the rigidity of the deformation of the control points mesh 112. For example, the greater the value of α, the more rigid the deformation, while the smaller the value of α, the less rigid the deformation. Using the final transformation function, T, generated using data for the control points in the control points mesh 306, the frame warper 304 can warp the control points in the control points mesh 306.

In one or more embodiments, the forward tracking process operates sequentially, iterating from a first video frame (e.g., modified video frame 300) through to a final frame of the video sequence by determining a transformation function between a current video frame and a next video frame. The transformation function is then applied to the control points in the current video frame to determine the second locations of control points 312 in second modified video frame 316. Upon completion of this iterative process, the position of the control points across all frames can be determined, represented as: {C₀, C₁, . . . , C_{T}}, where T is the number of video frames of the video sequence.

In one or more embodiments, the number of control points used for estimating both transformation functions is inherently flexible, which allows for inaccurate control points in the control points mesh 306 to be pruned or ignored. In some embodiments, these inaccurate control points can be identified by filtering with the cycle consistency check on optical flows, thus making the transformation functions resilient to inaccuracies in optical flow predictions. In one or more embodiments, to determine control points that can be pruned, the frame warper 304 first determines the backwards optical flow, or reverse optical flow, for a control point from video frame fₜ₊₁ to video frame fₜ, using the optical flow map 310. For example, after warping a control point from video frame fₜ to video frame fₜ₊₁ using forward optical flow, the frame warper 304 determines a transformation function (e.g., in the manner as described previously) to warp the control point from its location in video frame fₜ₊₁ to a location as determined by the transformation function. The frame warper 304 can then determine the distance from the original location of the control point to the location of the control point calculated using backwards optical flow. If the distance from the original location of the control point to the location of the control point calculated using backwards optical flow is greater than a threshold amount, the control point can be pruned from the set of control points in the control points mesh 306, or otherwise ignored.

In one or more embodiments, after the forward tracking process, the backwards warping process is performed to warp the new texture generated in the modified video frame 300 across other frames of the video sequence. In one or more embodiment, the frame warper 304 estimates a backwards warping function, T_{b}, by utilizing the known locations of control points on both video frame fₜ₊₁ (e.g., a target video frame) and video frame fₜ (e.g., the source video frame), as follows:

$${\hat{T}}_{b} = {argmin}_{{T}_{b}} ‖ {T}_{b} ( {C}_{t} ) - {C}_{s} ‖$$

In one or more embodiments, the backwards warping functions are modeled with Thin-Plate Spline transformations. In one or more embodiments, utilizing the deduced backwards mapping function enables the frame warper 304 to map each pixel on the target video frame back to the source video frame. The warped texture for the target video frame is then constructed using bilinear sampling to ensure smooth transitions and mitigate potential artifacts. Performing the forward tracking and backwards warping processes results in a robust and flexible transformation, adept at handling complex warping scenarios in video editing tasks.

The process of determining backwards warping function, T_{b}, can be repeated for any pair of video frames based on the determined locations of the control points. For example, to warp the texture from frame zero to frame ten, the control point location data for frame zero and the control point location data for frame ten, as determined by the forward tracking process, are used.

The forward tracking process is performed sequentially from video frame to video frame from a starting video frame to an ending video frame of the video sequence. However, because the control point location data for every video frame has been determined through the forward tracking process, warping of the new texture across video frames using the backwards warping process can be performed in parallel. For example, backwards warping can be performed between frames zero and ten, and between frames five and nine, at the same time.

FIG. 4 illustrates a diagram of a texture blending module for blending a new texture into a video frame of a video sequence in accordance with one or more embodiments. As illustrated in FIG. 4, a texture blending module 116 can include a texture blender 406. In one or more embodiments, the texture blender 406 is configured to automatically apply lighting and/or color changes to the new texture that has been warped into the warped video frames 402, in the process as described in FIG. 3.

The texture blending module 116 receives warped video frames 402, which can be generated in the process as described in FIG. 3. The texture blending module 116 can also receive the original source video frames of video sequence 404. The texture blending module 116 then can pass the warped video frames 402 and the original video frames of video sequence 404 to the texture blender 406. In one or more embodiments, the texture blender 406 uses Poisson blending using Gradient-Domain Image Editing (GDIE) to blend the warped textures in the warped video frames 402 with the regions bordering the warped textures to create a smooth transition to the warped texture. In one or more embodiments, the texture blender 406 transfers the differences (or gradients) between neighboring pixels, to preserve the detailed structures and the relative lighting of the source video frame (e.g., the original video frame from the video sequence 404). The texture blender 406 first combines/merges the gradient field of both the texture of the video frame, fₛ, and the target video frame, f_{T}, as follows:

$$G = m ⊙ ∇ {𝒥}_{b} ( {f}_{s} ) + ( 1 - m ) ⊙ ∇ {f}_{T}$$

where G denotes the combined gradient field, m, is a mask that indicates the location of the texture, ∇ symbolizes the gradient operator, and [symbol] (fₛ) represents the source video frame warped via the backwards warping process described in FIG. 3.

In one or more embodiments, to reconstruct an image (e.g., video frame) from the combined gradient field, the texture blender 406 uses Green Function Convolution (GFC). In such embodiments, the texture blender 406 transitions the gradient field to Fourier space, applies the Green Function, and then reverts back to the image domain. First, the texture blender 406 computes the Green Function kernel in the Fourier space, as follows:

$${K}_{green}^{ℱ} = \frac{ℱ ( δ )}{ℱ ( {L}_{{∇}^{2}} )}$$

where δ is Dirac's delta function, L_{∇}_{²} is the Laplacian Kernel, and [symbol] (⋅) signifies the Fast Fourier Transformation (FFT). A preliminary blended video frame 408, f_{blend}, is then derived by convoluting the combined gradient field G with the Green Function kernel in the Fourier space, followed by an inverse FFT [symbol] , as follows:

$${f}_{blend} = ℛ ( {ℱ}^{- 1} ( ℱ ( G ) ⊙ {K}_{green}^{ℱ} ) ) + c$$

where [symbol] (⋅) extracts the real part of a complex number and c is the integration constant.

In one or more embodiments, the FFT, being an approximation, can introduce minor errors when transitioning images to Fourier space and back from Fourier space. This can result in the preliminary blended video frame 408, f_{blend}, having lost details from the original, even in areas outside the area of the warped texture. For example, the FTT process can result in a loss of sharpness in the image. To recover some of the lost details, the texture blender 406 computes the high-frequency residuals 410 lost during the f_{blend} process by repeating the process with an uninterrupted gradient field derived from the target video frame, f_{T}. First, the texture blender 406 blends an empty, or transparent, image on the region of the warped texture in the target video frame, f_{T}, as follows:

$${f}_{blend 2} = ℛ ( {ℱ}^{- 1} ( ℱ ( ∇ {f}_{T} ) ⊙ {K}_{green}^{ℱ} ) ) + c$$

which results in an output with the high-frequency residuals lost. In one or more embodiments the empty image is a transparent image of the same size of the target video frame. The high-frequency residuals 410 can then be derived by subtracting the results of f_{blend2} from the target video frame, f_{T}, as follows:

$${f}_{res} = {f}_{T} - {f}_{blend 2}$$

The final blended video frame is the result the adding the high-frequency residuals 410, fᵣₑₛ, to the preliminary blended video frame 408, f_{blend}, as follows:

$${f}_{final} = {f}_{blend} + {f}_{res}$$

The process of generating the final blended video frame by combining the preliminary blended video frame 408 and the high-frequency residuals 410 is repeated for each of the warped video frames 402 of the video sequence, resulting in blended video frames 412.

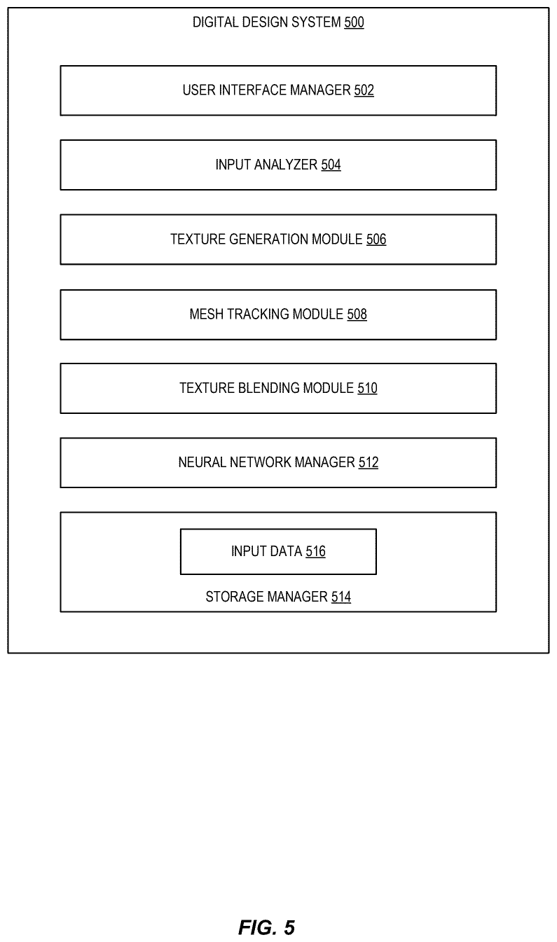

FIG. 5 illustrates a schematic diagram of a digital design system (e.g., “digital design system” described above) in accordance with one or more embodiments. As shown, the digital design system 500 may include, but is not limited to, a user interface manager 502, an input analyzer 504, a texture generation module 506, a mesh tracking module 508, a texture blending module 510, a neural network manager 512, and a storage manager 514. The storage manager 514 includes input data 516.

As illustrated in FIG. 5, the digital design system 500 includes a user interface manager 502. For example, the user interface manager 502 allows users to provide input data to the digital design system 500. In some embodiments, the user interface manager 502 provides a user interface through which the user can upload a document or file (e.g., a video sequence), as discussed above. Alternatively, or additionally, the user interface may enable the user to download the document or file from a local or remote storage location (e.g., by providing an address, such as a URL or other endpoint, associated with a data source).

As further illustrated in FIG. 5, the digital design system 500 also includes an input analyzer 504 that receives an input (e.g., from the user interface manager 502). The input analyzer 504 analyzes the input received to identify a video sequence from the input. In one or more embodiments, the input analyzer 504 can also receive and process a text input and a selection of a region of a video frame of the video sequence. The text input and the selection of the selected region can be received in the same input as the video sequence, or in an additional input. In one or more embodiments, the text input is a response to a text prompt that describes a new texture to be generated in the selected region.

As further illustrated in FIG. 5, the digital design system 500 also includes a texture generation module 506 trained to generate a modified image or modified video frame of a video sequence with a new texture. In one or more embodiments, the texture generation module 506 generates the new texture in a selected region of a video frame (e.g., based on the input). In one or more embodiments, the texture generation module 506 is machine learning model trained to modify an image, or video frame, by adding or removing content from the image. In some embodiments, the texture generation module 506 can add a texture, an object, or an element to the image based on a text prompt received in the input. In the absence of a text prompt, the texture generation module 506 can fill in the selected region based on the selected region's surroundings. For example, the texture generation module 506 can remove a group of people in the background of a video frame and replace them with a filled in background, or the texture generation module 506 can add a tie to a person in the video frame, etc. In one or more embodiments, the texture generation module 506 includes a trained neural network to generate the new texture in the video frame. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

As further illustrated in FIG. 5, the digital design system 500 also includes a mesh tracking module 508 configured to propagate the new texture generated by the texture generation module 506 in the modified video frame to all other frames in the video sequence. In one or more embodiments, the mesh tracking module 508 generates a control points mesh for the selected region of the modified video frame that includes the new texture. After generating the control points mesh for the modified video frame, the mesh tracking module 508 generates control point location data for each control point by using an optical flow map to analyze the motion of each control point. Based on the analyzed motion, the mesh tracking module 508 generates a transformation function to compute how to warp the control points from one video frame of the video sequence to the next video frame. After determining how to warp the control points, the mesh tracking module 508 then warps the new texture based on the warped control points to generate warped video frames.

As further illustrated in FIG. 5, the digital design system 500 also includes a texture blending module 510. In one or more embodiments, the texture blending module 510 receives the warped video frames generated by the mesh tracking module 508. The texture blending module 510 can be configured to blend the warped texture in the warped video frames with the original content in the original source video frame from the video sequence to ensure the new texture visually matches shifting lighting conditions of the original source video frames.

As illustrated in FIG. 5, the digital design system 500 also includes a neural network manager 512. Neural network manager 512 may host a plurality of neural networks or other machine learning models used by the modules of the digital design system 500. The neural network manager 512 may include an execution environment, libraries, and/or any other data needed to execute the machine learning models. In some embodiments, the neural network manager 512 may be associated with dedicated software and/or hardware resources to execute the machine learning models. Although depicted in FIG. 5 as being hosted by a single neural network manager 512, in various embodiments the neural networks may be hosted in multiple neural network managers and/or as part of different components.

As illustrated in FIG. 5, the digital design system 500 also includes the storage manager 514. The storage manager 514 maintains data for the digital design system 500. The storage manager 514 can maintain data of any type, size, or kind as necessary to perform the functions of the digital design system 500. The storage manager 514, as shown in FIG. 5, includes input data 516. In particular, the input data 516 may include a video sequence received by the digital design system 500.

Each of the components 502-514 of the digital design system 500 and their corresponding elements (as shown in FIG. 5) may be in communication with one another using any suitable communication technologies. It will be recognized that although components 502-514 and their corresponding elements are shown to be separate in FIG. 5, any of components 502-514 and their corresponding elements may be combined into fewer components, such as into a single facility or module, divided into more components, or configured into different components as may serve a particular embodiment.

The components 502-514 and their corresponding elements can comprise software, hardware, or both. For example, the components 502-514 and their corresponding elements can comprise one or more instructions stored on a computer-readable storage medium and executable by processors of one or more computing devices. When executed by the one or more processors, the computer-executable instructions of the digital design system 500 can cause a client device and/or a server device to perform the methods described herein. Alternatively, the components 502-514 and their corresponding elements can comprise hardware, such as a special purpose processing device to perform a certain function or group of functions. Additionally, the components 502-514 and their corresponding elements can comprise a combination of computer-executable instructions and hardware.

Furthermore, the components 502-514 of the digital design system 500 may, for example, be implemented as one or more stand-alone applications, as one or more modules of an application, as one or more plug-ins, as one or more library functions or functions that may be called by other applications, and/or as a cloud-computing model. Thus, the components 502-514 of the digital design system 500 may be implemented as a stand-alone application, such as a desktop or mobile application. Furthermore, the components 502-514 of the digital design system 500 may be implemented as one or more web-based applications hosted on a remote server. Alternatively, or additionally, the components of the digital design system 500 may be implemented in a suite of mobile device applications or “apps.”

As shown, the digital design system 500 can be implemented as a single system. In other embodiments, the digital design system 500 can be implemented in whole, or in part, across multiple systems. For example, one or more functions of the digital design system 500 can be performed by one or more servers, and one or more functions of the digital design system 500 can be performed by one or more client devices. The one or more servers and/or one or more client devices may generate, store, receive, and transmit any type of data used by the digital design system 500, as described herein.

In one implementation, the one or more client devices can include or implement at least a portion of the digital design system 500. In other implementations, the one or more servers can include or implement at least a portion of the digital design system 500. For instance, the digital design system 500 can include an application running on the one or more servers or a portion of the digital design system 500 can be downloaded from the one or more servers. Additionally, or alternatively, the digital design system 500 can include a web hosting application that allows the client device(s) to interact with content hosted at the one or more server(s).

For example, upon a client device accessing a webpage or other web application hosted at the one or more servers, in one or more embodiments, the one or more servers can provide access to one or more files including documents (e.g., PDF documents) stored at the one or more servers. The one or more servers can then automatically perform the methods and processes described above to apply and blend new textures to surfaces across frames of a video sequence.

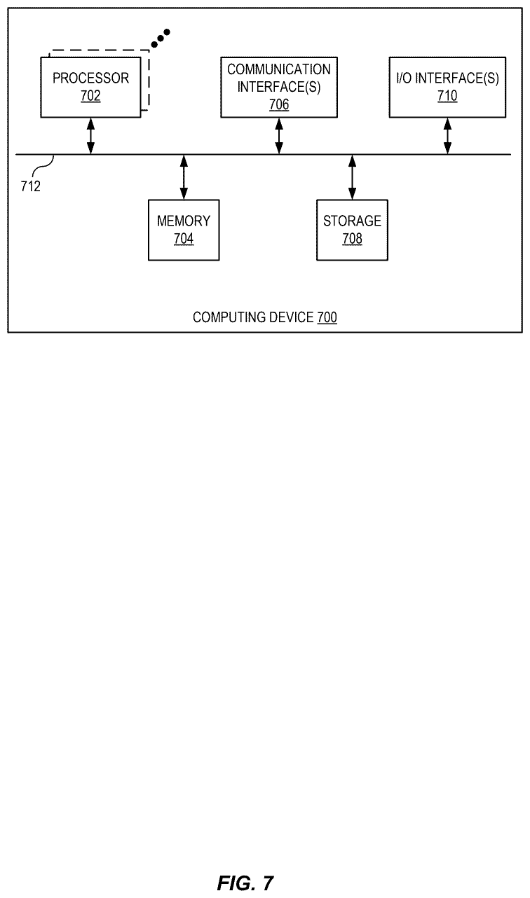

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 7. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 7.

The server(s) may include one or more hardware servers (e.g., hosts), each with its own computing resources (e.g., processors, memory, disk space, networking bandwidth, etc.) which may be securely divided between multiple customers (e.g., client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 7.

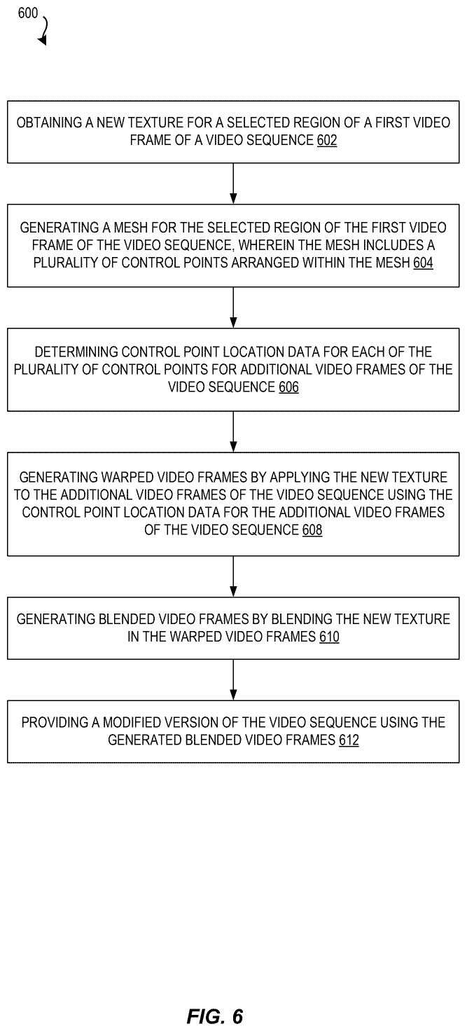

FIGS. 1-5, the corresponding text, and the examples, provide a number of different systems and devices that apply and blend new textures to surfaces across frames of a video sequence in accordance with one or more embodiments. In addition to the foregoing, embodiments can also be described in terms of flowcharts comprising acts and steps in a method for accomplishing a particular result. For example, FIG. 6 illustrate flowcharts of exemplary methods in accordance with one or more embodiments. The methods described in relation to FIG. 6 may be performed with fewer or more steps/acts or the steps/acts may be performed in differing orders. Additionally, the steps/acts described herein may be repeated or performed in parallel with one another or in parallel with different instances of the same or similar steps/acts.

FIG. 6 illustrates a flowchart of a series of acts in a method of applying and blending new textures to surfaces across frames of a video sequence in accordance with one or more embodiments. In one or more embodiments, the method 600 is performed in a digital medium environment that includes the digital design system 500. The method 600 is intended to be illustrative of one or more methods in accordance with the present disclosure and is not intended to limit potential embodiments. Alternative embodiments can include additional, fewer, or different steps than those articulated in FIG. 6.

As illustrated in FIG. 6, the method 600 includes an act 602 of obtaining a new texture for a selected region of a first video frame of a video sequence. In one or more embodiments, a digital design system (e.g., digital design system 500) receives an input that includes a video sequence. The digital design system can also receive an indication of a selected region of a first video frame of the video sequence and a prompt describing a new texture to be applied in the selected region of the first video frame of the video sequence. In one or more embodiments, the new texture is generated by a texture generation module. In one or more embodiments, the texture generation module is machine learning model trained to modify an image, or video frame, by adding or removing content from the image. For example, the texture generation module can add a texture, an object, or an element to the image based on the prompt. The added texture, object, or element can be obtained by the texture generation module and/or generated by the texture generation module. The prompt can be a text prompt describing the new texture to be added. In the absence of a text prompt, the texture generation module can fill in the selected region based on the selected region's surroundings. In one or more embodiments, the texture generation module includes a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

As illustrated in FIG. 6, the method 600 includes an act 604 of generating a mesh for the selected region of the first video frame of the video sequence, wherein the mesh includes a plurality of control points arranged within the mesh. In one or more embodiments, the digital design system includes a mesh tracking module that includes a control points mesh generator configured to generate, or create, the mesh, or control points mesh, for the selected region of the first video frame of the video sequence with the new texture. The control points mesh generator can generate the mesh by dividing the selected region of the first video frame into a grid based on the shape of the selected region of the first video frame. For example, each vertex of the grid can define a location of a control point for the mesh, where a larger grid size results in fewer control points (e.g., due to fewer vertices), and vice versa. In one or more embodiments, the initial locations of the control points of the mesh are uniformly distributed within the selected region (e.g., the distance between each control point is uniform or close to uniform). This distance between control points can be either user-defined or system-defined. In some embodiments, the user or system can define a number of control points, with the grid correspondingly created with a number of vertices matching the defined number of control points.

As illustrated in FIG. 6, the method 600 includes an act 606 of determining control point location data for each of the plurality of control points for additional video frames of the video sequence. In one or more embodiments, the mesh tracking module also includes a frame warper configured to determine the control point location data based on the motion of the control points from one video frame to the next video frame. In one or more embodiments, the frame warper performs a forward tracking process to determine the control point location data for the control points for the additional video frames of the video sequence on which the new texture is to be applied.

In one or more embodiments, for a first video frame and a second video frame that are consecutive video frames of the video sequence, the frame warper determines the motions of each control point from the first video frame to the second video frame. To do so, the frame warper retrieves or accesses an optical flow map of the video sequence that tracks the motion of all pixels from one video frame to the next video frame. In one or more embodiments, the optical flow map is generated using a machine learning model. In some embodiments, the optical flow map is generated using a Recurrent All-Pairs Field Transforms (RAFT) machine learning model.

In one or more embodiments, the frame warper generates a transformation function representing the deformation of the plurality of control points using the motions of each of the plurality of control points determine from using the optical flow map. In such embodiments, the frame warper first defines two transformation functions: a similarity transformation function, Tᵣ, which represents rigid deformation, and a Thin-Plate transformation function, Tₛ, which represents non-rigid deformation. The frame warper uses the optical flow map for second frame to analyze the individual motions of the control points in the control points mesh from the first frame to the second frame. By comparing the first locations of the control points in the first video frame, Cₜ, to second locations of the control points in the second video frame, F(Cₜ), the frame warper can define the two transformation functions, as follows:

$${\hat{T}}_{r} = {arg min}_{{T}_{r}} ‖ {T}_{r} ( {C}_{t} ) - F ( {C}_{t} ) ‖$$

$${\hat{T}}_{s} = {arg min}_{{T}_{s}} ‖ {T}_{s} ( {C}_{t} ) - F ( {C}_{t} ) ‖$$

In one or more embodiments, the final transformation function, T, is the weighted combination of the two transformation functions, as follows:

$${C}_{t + 1} = T ( {C}_{t} ) = α {T}_{r} ( {C}_{t} ) + ( 1 - α ) {T}_{s} ( {C}_{t} )$$

where α can be a user-defined value that allows for control of the rigidity of the deformation of the control points mesh. For example, the greater the value of α, the more rigid the deformation, while the smaller the value of α, the less rigid the deformation. Using the final transformation function, T, to warp the control points in the control points mesh from the first video frame to the second video frame, the frame warper can generate location data for each of the control points in the second video frame. The frame warper can then repeat the process from the second video frame to the third video frame, and so on through the video sequence.

As illustrated in FIG. 6, the method 600 includes an act 608 of generating warped video frames by applying the new texture to the additional video frames of the video sequence using the control point location data for the additional video frames of the video sequence. The control point location data generated from processing of the additional video frames through the forward tracking process is used to generate the warped video frames through a backwards warping process. In one or more embodiment, the frame warper estimates a backwards warping function, T_{b}, by utilizing the known locations of control points on both a target video frame and a source video frame, as follows:

$${\hat{T}}_{b} = {arg min}_{{T}_{b}} ‖ {T}_{b} ( {C}_{t} ) - ( {C}_{s} ) ‖$$

where the source video frame is the first video frame and the target video frame is a subsequent video frame. The subsequent video frame can be any video frame in the video sequence as the backwards warping process does not need to be performed in a consecutive manner because the control point location data for every video frame has been determined through the forward tracking process. Thus, the process of determining backwards warping function, T_{b}, can be repeated for any pair of video frames based on the determined locations of the control points. For example, to warp the texture from frame zero to frame ten, the control point location data for frame zero and the control point location data for frame ten, as determined by the forward tracking process, are used, while the control point location data for frames between frame zero and frame ten can be ignored.

In one or more embodiments, the backwards warping functions are modeled with Thin-Plate Spline transformations. In one or more embodiments, utilizing the deduced backwards mapping function enables the frame warper to map each pixel on the target video frame back to the source video frame. The warped texture for the target video frame is then constructed using bilinear sampling to ensure smooth transitions and mitigate potential artifacts.

As illustrated in FIG. 6, the method 600 includes an act 610 of generating blended video frames by blending the new texture in the warped video frames. In one or more embodiments, the digital design system includes a texture blending module configured to automatically apply lighting and/or color changes to the new texture that has been warped into the additional video frames of the video sequence. In one or more embodiments, the texture blending module uses Poisson blending using Gradient-Domain Image Editing (GDIE) to blend the warped textures in the warped video frames with the regions bordering the warped textures to create a smooth transition to the warped texture. In one or more embodiments, the texture blending module transfers the differences (or gradients) between neighboring pixels, to preserve the detailed structures and the relative lighting of the source video frame (e.g., the original video frame from the video sequence). The texture blending module first combines/merges the gradient field of both the texture of the video frame, fₛ, and the target video frame, f_{T}, as follows:

$$G = m ⊙ ∇ {𝒥}_{b} ( {f}_{s} ) + ( 1 - m ) ⊙ ∇ {f}_{T}$$

where G denotes the combined gradient field, m, is a mask that indicates the location of the texture, ∇ symbolizes the gradient operator, and [symbol] (fₛ) represents the source video frame warped via the backwards warping process.

In one or more embodiments, to reconstruct an image (e.g., video frame) from the combined gradient field, the texture blending module uses Green Function Convolution (GFC). In such embodiments, the texture blending module transitions the gradient field to Fourier space, applies the Green Function, and then reverts back to the image domain. First, the texture blending module computes the Green Function kernel in the Fourier space, as follows:

$${K}_{green}^{ℱ} = \frac{ℱ ( δ )}{ℱ ( {L}_{{∇}^{2}} )}$$

where δ is Dirac's delta function, L_{∇}_{²} is the Laplacian Kernel, and [symbol] (⋅) signifies the Fast Fourier Transformation (FFT). A preliminary blended video frame, f_{blend}, is then derived by convoluting the combined gradient field G with the Green Function kernel in the Fourier space, followed by an inverse FFT [symbol] , as follows:

$${f}_{blend} = ℛ ( {ℱ}^{- 1} ( ℱ ( G ) ⊙ {K}_{green}^{ℱ} ) ) + c$$

where [symbol] (⋅) extracts the real part of a complex number and c is the integration constant.

In one or more embodiments, the FFT, being an approximation, can introduce minor errors when transitioning images to Fourier space and back from Fourier space. This can result in the preliminary blended video frame, f_{blend}, having lost details from the original, even in areas outside the area of the warped texture. For example, the FTT process can result in a loss of sharpness in the image. To recover some of the lost details, the texture blending module computes the high-frequency residuals lost during the f_{blend} process by repeating the process with an uninterrupted gradient field derived from the target video frame, f_{T}. First, the texture blending module blends an empty image on the region of the warped texture in the target video frame, f_{T}, as follows:

$${f}_{blend 2} = ℛ ( {ℱ}^{- 1} ( ℱ ( ∇ {f}_{T} ) ⊙ {K}_{green}^{ℱ} ) ) + c$$

which results in an output with the high-frequency residuals lost. In one or more embodiments the empty image is a transparent image of the same size of the target video frame. The high-frequency residuals can then be derived by subtracting the results of f_{blend2} from the target video frame, f_{T}, as follows:

$${f}_{res} = {f}_{T} - {f}_{blend 2}$$

The final blended video frame is the result the adding the high-frequency residuals, fᵣₑₛ, to the preliminary blended video frame, f_{blend}, as follows:

$${f}_{final} = {f}_{blend} + {f}_{res}$$

The process of generating the final blended video frame by combining the preliminary blended video frame and the high-frequency residuals is repeated for each of the warped video frames of the video sequence, resulting in the blended video frames.

As illustrated in FIG. 6, the method 600 includes an act 612 of providing a modified version of the video sequence using the generated blended video frames. In one or more embodiments, the blended video frames 118 can be used to generate the modified video sequence and provided as an output to a user.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 7 illustrates, in block diagram form, an exemplary computing device 700 that may be configured to perform one or more of the processes described above. One will appreciate that one or more computing devices such as the computing device 700 may implement the digital design system. As shown by FIG. 7, the computing device can comprise a processor 702, memory 704, one or more communication interfaces 706, a storage device 708, and one or more I/O devices/interfaces 710. In certain embodiments, the computing device 700 can include fewer or more components than those shown in FIG. 7. Components of computing device 700 shown in FIG. 7 will now be described in additional detail.

In particular embodiments, processor(s) 702 includes hardware for executing instructions, such as those making up a computer program. As an example, and not by way of limitation, to execute instructions, processor(s) 702 may retrieve (or fetch) the instructions from an internal register, an internal cache, memory 704, or a storage device 708 and decode and execute them. In various embodiments, the processor(s) 702 may include one or more central processing units (CPUs), graphics processing units (GPUs), field programmable gate arrays (FPGAs), systems on chip (SoC), or other processor(s) or combinations of processors.

The computing device 700 includes memory 704, which is coupled to the processor(s) 702. The memory 704 may be used for storing data, metadata, and programs for execution by the processor(s). The memory 704 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 704 may be internal or distributed memory.

The computing device 700 can further include one or more communication interfaces 706. A communication interface 706 can include hardware, software, or both. The communication interface 706 can provide one or more interfaces for communication (such as, for example, packet-based communication) between the computing device and one or more other computing devices 700 or one or more networks. As an example, and not by way of limitation, communication interface 706 may include a network interface controller (NIC) or network adapter for communicating with an Ethernet or other wire-based network or a wireless NIC (WNIC) or wireless adapter for communicating with a wireless network, such as a WI-FI. The computing device 700 can further include a bus 712. The bus 712 can comprise hardware, software, or both that couples components of computing device 700 to each other.

The computing device 700 includes a storage device 708 includes storage for storing data or instructions. As an example, and not by way of limitation, storage device 708 can comprise a non-transitory storage medium described above. The storage device 708 may include a hard disk drive (HDD), flash memory, a Universal Serial Bus (USB) drive or a combination these or other storage devices. The computing device 700 also includes one or more input or output (“I/O”) devices/interfaces 710, which are provided to allow a user to provide input to (such as user strokes), receive output from, and otherwise transfer data to and from the computing device 700. These I/O devices/interfaces 710 may include a mouse, keypad or a keyboard, a touch screen, camera, optical scanner, network interface, modem, other known I/O devices or a combination of such I/O devices/interfaces 710. The touch screen may be activated with a stylus or a finger.

The I/O devices/interfaces 710 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 710 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining a new texture for a selected region of a first video frame of a video sequence;
generating a mesh for the selected region of the first video frame of the video sequence, wherein the mesh includes a plurality of control points arranged within the mesh;
determining control point location data for each of the plurality of control points for additional video frames of the video sequence;
generating warped video frames by applying the new texture to the additional video frames of the video sequence using the control point location data for the additional video frames of the video sequence;
generating blended video frames by blending the new texture in the warped video frames; and
providing a modified version of the video sequence using the generated blended video frames.

2. The method of claim 1, wherein determining the control point location data for each of the plurality of control points for the additional video frames of the video sequence further comprises:
for each pair of consecutive video frames of the video sequence:
determining motions of each of the plurality of control points from the first video frame of the video sequence to a second video frame of the video sequence from an optical flow mapping of the video sequence,
generating a transformation function representing deformation of the plurality of control points using the determined motions of each of the plurality of control points,
generating locations for each of the plurality of control points in the second video frame of the video sequence by warping the plurality of control points from the first video frame of the video sequence using the generated transformation function, and
storing the generated locations for each of the plurality of control points in the second video frame of the video sequence as the control point location data.

3. The method of claim 2, further comprising:
determining a reverse optical flow location of a control point in the first video frame of the video sequence using a reverse optical flow mapping from the second video frame of the video sequence to the first video frame of the video sequence;
calculating a distance between an original location of the control point and a reverse optical flow location of the control point; and
removing the control point from the plurality of control points when the calculated distance is greater than a threshold value.

4. The method of claim 2, wherein generating the warped video frames by applying the new texture to the additional video frames of the video sequence using the control point location data for the additional video frames of the video sequence further comprises:
determining first control point location data for the first video frame and second control point location data for a target video frame of the video sequence from the generated control point location data;
generating a warping function using the first control point location data and the second control point location data; and
warping the new texture from the first video frame to the target video frame using the generated warping function.

5. The method of claim 4, wherein generating the blended video frames by blending the new texture in the warped video frames further comprises:
for each video frame of the additional video frames of the video sequence:
generating a preliminary blend by blending the new texture with the region in the video frame,
computing high-frequency residuals lost during the generating of the preliminary blending by blending a transparent image with the video frame, and
computing a final blend of the new texture with the region in the video frame by merging the preliminary blend and the computed high-frequency residuals.

6. The method of claim 2, wherein generating the transformation function representing the deformation of the plurality of control points using the determined motions of each of the plurality of control points further comprises:
generating a first transformation function representing rigid deformation and a second transformation function representing non-rigid deformation; and
generating the transformation function by applying a weighting to the first transformation function and the second transformation function.

7. The method of claim 1, wherein generating the blended video frames by blending the new texture in the warped video frames comprises:
receiving a second input including a prompt, the prompt indicating a requested texture for the selected region of the first video frame.

8. A non-transitory computer-readable medium storing executable instructions, which when executed by a processing device, cause the processing device to perform operations comprising:
obtaining a new texture for a selected region of a first video frame of a video sequence;
generating a mesh for the selected region of the first video frame of the video sequence, wherein the mesh includes a plurality of control points arranged within the mesh;
determining control point location data for each of the plurality of control points for additional video frames of the video sequence;
generating warped video frames by applying the new texture to the additional video frames of the video sequence using the control point location data for the additional video frames of the video sequence;
generating blended video frames by blending the new texture in the warped video frames; and
providing a modified version of the video sequence using the generated blended video frames.

9. The non-transitory computer-readable medium of claim 8, wherein the instructions to determine the control point location data for each of the plurality of control points for the additional video frames of the video sequence further comprises:
for each pair of consecutive video frames of the video sequence:
determining motions of each of the plurality of control points from the first video frame of the video sequence to a second video frame of the video sequence from an optical flow mapping of the video sequence,
generating a transformation function representing deformation of the plurality of control points using the determined motions of each of the plurality of control points,
generating locations for each of the plurality of control points in the second video frame of the video sequence by warping the plurality of control points from the first video frame of the video sequence using the generated transformation function, and
storing the generated locations for each of the plurality of control points in the second video frame of the video sequence as the control point location data.

10. The non-transitory computer-readable medium of claim 9, storing instructions that further cause the processing device to perform operations comprising:
determining a reverse optical flow location of a control point in the first video frame of the video sequence using a reverse optical flow mapping from the second video frame of the video sequence to the first video frame of the video sequence;
calculating a distance between an original location of the control point and a reverse optical flow location of the control point; and
removing the control point from the plurality of control points when the calculated distance is greater than a threshold value.

11. The non-transitory computer-readable medium of claim 9, wherein the instructions to generate the warped video frames by applying the new texture to the additional video frames of the video sequence using the control point location data for the additional video frames of the video sequence further comprise:
determining first control point location data for the first video frame and second control point location data for a target video frame of the video sequence from the generated control point location data;
generating a warping function using the first control point location data and the second control point location data; and
warping the new texture from the first video frame to the target video frame using the generated warping function.

12. The non-transitory computer-readable medium of claim 11, wherein the instructions to generate the blended video frames by blending the new texture in the warped video frames further comprise:
for each video frame of the additional video frames of the video sequence:
generating a preliminary blend by blending the new texture with the region in the video frame,
computing high-frequency residuals lost during the generating of the preliminary blending by blending a transparent image with the video frame, and
computing a final blend of the new texture with the region in the video frame by merging the preliminary blend and the computed high-frequency residuals.

13. The non-transitory computer-readable medium of claim 9, wherein the instructions to generate the transformation function representing the deformation of the plurality of control points using the determined motions of each of the plurality of control points further comprise:
generating a first transformation function representing rigid deformation and a second transformation function representing non-rigid deformation; and
generating the transformation function by applying a weighting to the first transformation function and the second transformation function.

14. The non-transitory computer-readable medium of claim 8, wherein the instructions to generate the blended video frames by blending the new texture in the warped video further comprise:
receiving a second input including a prompt, the prompt indicating a requested texture for the selected region of the first video frame.

15. A system comprising:
a memory component; and
a processing device coupled to the memory component, the processing device to perform operations comprising:
obtaining a new texture for a selected region of a first video frame of a video sequence;
generating a mesh for the selected region of the first video frame of the video sequence, wherein the mesh includes a plurality of control points arranged within the mesh;
determining control point location data for each of the plurality of control points for additional video frames of the video sequence;
generating warped video frames by applying the new texture to the additional video frames of the video sequence using the control point location data for the additional video frames of the video sequence;
generating blended video frames by blending the new texture in the warped video frames; and
providing a modified version of the video sequence using the generated blended video frames.

16. The system of claim 15, wherein the operations of determining the control point location data for each of the plurality of control points for the additional video frames of the video sequence further comprise:
for each pair of consecutive video frames of the video sequence:
determining motions of each of the plurality of control points from the first video frame of the video sequence to a second video frame of the video sequence from an optical flow mapping of the video sequence,
generating a transformation function representing deformation of the plurality of control points using the determined motions of each of the plurality of control points,
generating locations for each of the plurality of control points in the second video frame of the video sequence by warping the plurality of control points from the first video frame of the video sequence using the generated transformation function, and
storing the generated locations for each of the plurality of control points in the second video frame of the video sequence as the control point location data.

17. The system of claim 16, wherein the processing device performs further operations comprising:
determining a reverse optical flow location of a control point in the first video frame of the video sequence using a reverse optical flow mapping from the second video frame of the video sequence to the first video frame of the video sequence;
calculating a distance between an original location of the control point and a reverse optical flow location of the control point; and
removing the control point from the plurality of control points when the calculated distance is greater than a threshold value.

18. The system of claim 16, wherein the operations of generating the warped video frames by applying the new texture to the additional video frames of the video sequence using the control point location data for the additional video frames of the video sequence further comprise:
determining first control point location data for the first video frame and second control point location data for a target video frame of the video sequence from the generated control point location data;
generating a warping function using the first control point location data and the second control point location data; and
warping the new texture from the first video frame to the target video frame using the generated warping function.

19. The system of claim 18, wherein the operations of generating the blended video frames by blending the new texture in the warped video frames further comprise:
for each video frame of the additional video frames of the video sequence:
generating a preliminary blend by blending the new texture with the region in the video frame,
computing high-frequency residuals lost during the generating of the preliminary blending by blending a transparent image with the video frame, and
computing a final blend of the new texture with the region in the video frame by merging the preliminary blend and the computed high-frequency residuals.

20. The system of claim 16, wherein the operations of generating the transformation function representing the deformation of the plurality of control points using the determined motions of each of the plurality of control points comprise:
generating a first transformation function representing rigid deformation and a second transformation function representing non-rigid deformation; and
generating the transformation function by applying a weighting to the first transformation function and the second transformation function.
